(19) United States
(12) Patent Application Publication
(10) Pub. No.: US 2007/0143130 A1
(43) Pub. Date: Jun. 21, 2007

(54) Network of instruction stations

(75) Inventor: Thomas F. Hearn, Boerne, TX (US)

Correspondence Address: DAVID LEWIS, 1250 AVIATION AVE., SUITE 200B, SAN JOSE, CA, 95110, US

(73) Assignee: Xstream Instructions, Ltd.

(21) Appl. No.: 11/401,086

(22) Filed: Apr. 10, 2006

Related U.S. Application Data
(60) Provisional application No. 60/751,846, filed on Dec. 20, 2005.

(51) Int. Cl. G06Q 99/00

(52) U.S. Cl. 705/1; 434/247

(57) ABSTRACT

In an embodiment, a student may be provided with instructions via computer in an area in which illustrating the physical positioning of the human body or other object may be beneficial. In an embodiment a system of one or more instruction stations may be provided where the student may record practice sessions and/or view prerecorded lessons without the presence of the instructor. In an embodiment, at a later date the instructor may view the recorded practice sessions, and prepare a video that may include a critique of the recorded practice session and/or a new lesson. In an embodiment, a student may initiate the video or lesson review process at any time from any number of devices having access to one or more networks having the source video file saved on any number of devices accessible by the network.

### CROSS-REFERENCE TO RELATED APPLICATIONS

This application claims priority benefit of U.S. Provisional Patent Application No. 60/751,846, entitled “Network of Instructional Kiosks,” filed Dec. 20, 2005, by Thomas F. Hearn, which is incorporated herein by reference.

### FIELD

This specification is generally related to providing instructions in an area of interest, such as a sport.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

In the prior art, when a student wants to receive lessons in a particular field, such as golf, another sport, music, or another area where customarily a face-to-face lesson is considered beneficial, the student schedules a meeting with an instructor to receive lessons.

### BRIEF DESCRIPTION OF THE FIGURES

In the following drawings like reference numbers are used to refer to like elements. Although the following figures depict various examples of the invention, the invention is not limited to the examples depicted in the figures.

FIG. 1A shows a block diagram of an example of an instruction system.

FIG. 1B shows a block diagram of an embodiment of the server system in combination with the network of FIG. 1A.

FIG. 1C shows a block diagram illustrating some of the communication paths that may be used in the instruction system of FIG. 1A.

FIG. 2 shows a diagram of an example of one of the instruction stations of FIG. 1A.

FIG. 3 shows a block diagram of a machine that may be used for various consoles, network appliances and/or servers in FIGS. 1A-C and 2.

FIG. 4 shows a block diagram of an example of a memory of the machine of FIG. 3.

FIG. 5 shows a block diagram of an example of a memory of another embodiment of the machine of FIG. 3.

FIG. 6 shows a block diagram of an example of instructor portion of FIG. 5.

FIG. 7 shows a block diagram of an example of a franchisee portal of FIG. 5.

FIG. 8 shows a block diagram of an example of the flow of information in managing advertisements within the system of FIGS. 1A and 1B.

FIG. 9 shows a flowchart of an example of a method of setting up the instruction system of FIG. 1A.

FIG. 10 shows a flowchart of an example of a method of updating advertisements on the instruction system of FIG. 1A.

FIG. 11 shows a flowchart of an example of a method of using the instruction system of FIG. 1A.

### DETAILED DESCRIPTION

Although various embodiments of the invention may have been motivated by various deficiencies with the prior art, which may be discussed or alluded to in one or more places in the specification, the embodiments of the invention do not necessarily address any of these deficiencies. In other words, different embodiments of the invention may address different deficiencies that may be discussed in the specification. Some embodiments may only partially address some deficiencies or just one deficiency that may be discussed in the specification, and some embodiments may not address any of these deficiencies.

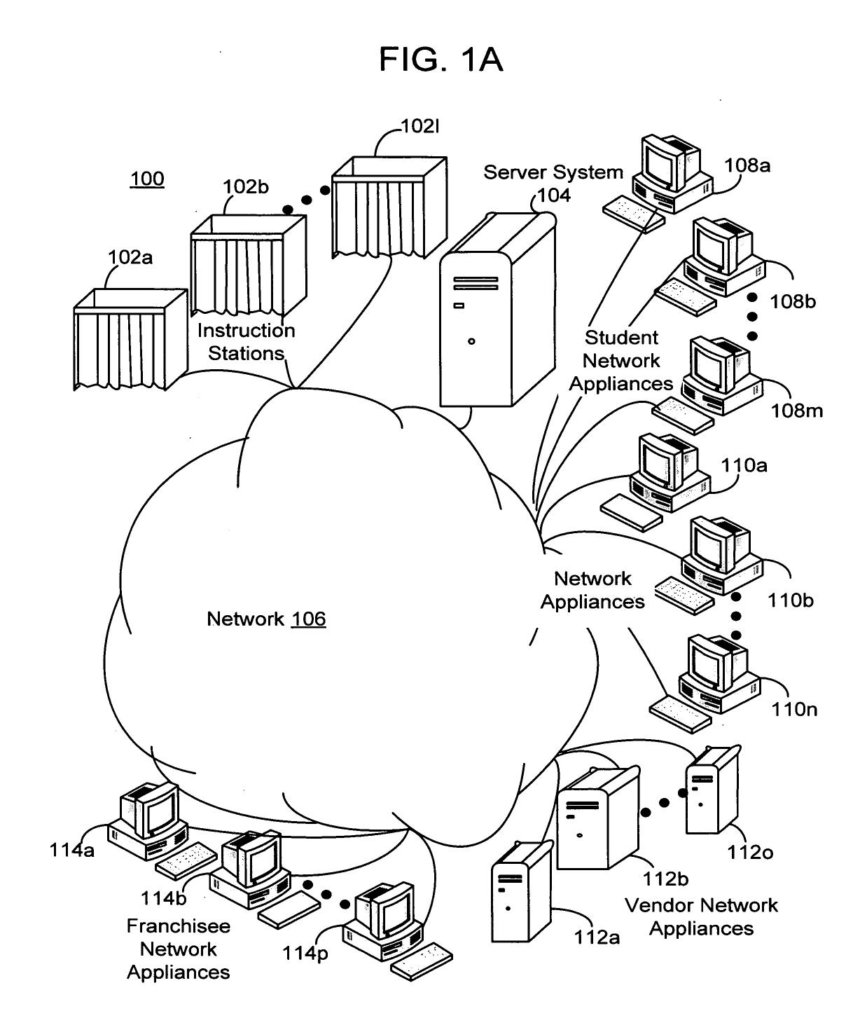

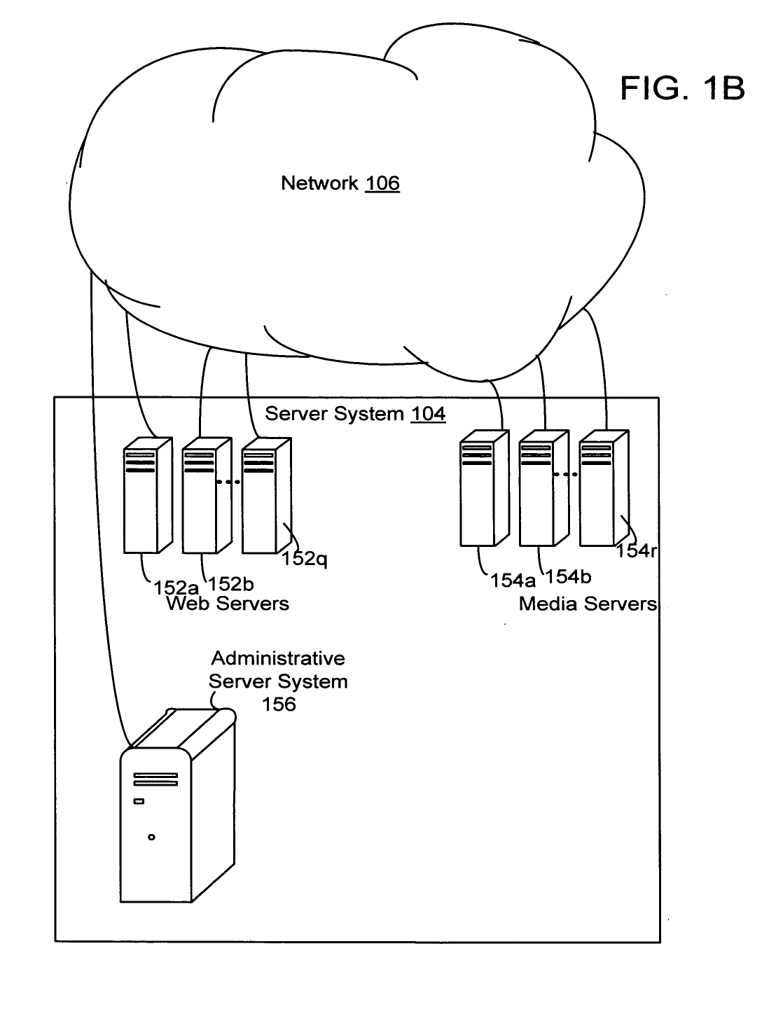

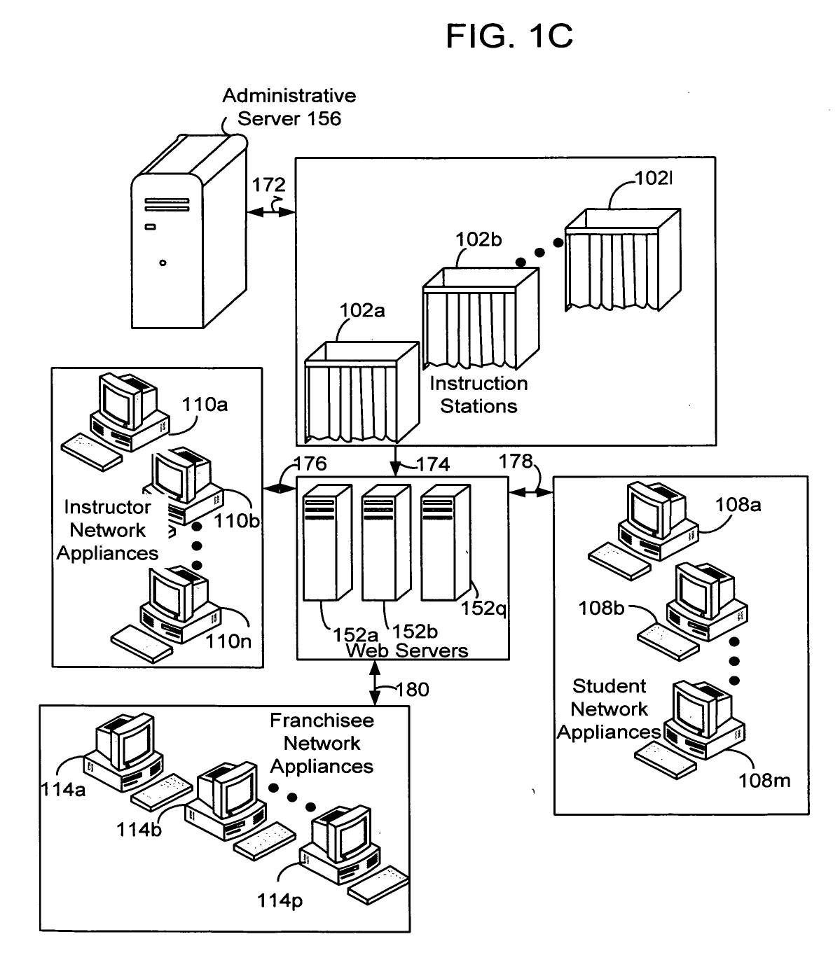

In general, at the beginning of the discussion of each of FIGS. 1-8 is a brief description of each element, which may have no more than the name of each of the elements in the one of FIGS. 1-8 that is being discussed. After the brief description of each element, each element is further discussed in numerical order. In general, each of FIGS. 1-11 is discussed in numerical order and the elements within FIGS. 1-11 are also usually discussed in numerical order to facilitate easily locating the discussion of a particular element. Nonetheless, there is no one location where all of the information of any element of FIGS. 1-11 is necessarily located. Unique information about any particular element or any other aspect of any of FIGS. 1-11 may be found in, or implied by, any part of the specification.

In various places in discussing the drawings a range of letters, such as a-l, a-m, a-n, a-o, a-p, a-q, a-r, and a-s are used to refer to individual elements of various series of elements that are the same. In each of these series, the ending letters are integer variables that can be any number. Unless indicated otherwise, the number of elements in each of these series is unrelated to the number of elements in others of these series. Specifically, even though one letter (e.g. “m”) comes earlier in the alphabet than another letter (e.g., “n”), the order of these letters in the alphabet does not mean that the earlier letter represents a smaller number. The value of the earlier letter is unrelated to the later letter, and may represent a value that is greater than, the same as, or less than the later letter. The ellipses in the figures, which may be located between any two items, indicate that any number of similar items may be included between those two items

FIG. 1A shows a block diagram of an example of an instruction system 100. Instruction system 100 may include instruction stations 102a-l, server system 104, network 106, student network appliances 108a-m, instructor network appliances 1110a-n, vendor network appliances 112a-o, and franchisee network appliances 114a-p. In other embodiments, instruction system 100 may not include all of the components listed above and/or may include other components in addition to or instead of the components listed above.

Instruction system 100 provides instructions in an activity of interest for which in-person instructions are usually desirable. Instruction system 100 may be a substitute for receiving in-person instructions. For example, instruction system 100 may be used for providing instructions in an activity in which the positioning of a part of the body is significant for proper performance of the activity, such as golf, tennis, baseball, basketball, rock climbing, acting, exercising, yoga, karate, kickboxing, judo, another physical activity. In an embodiment, instruction system 100 may be used for providing instructions for playing a musical instrument, such as a violin, piano, guitar, or any other activity in which physical positioning of objects, animals, or the human body may be significant. In an embodiment instruction system 100 may be used for giving instruction in any activity for which viewing an object or activity is significant. Although in most of this specification, golf may be used as an example, any of the above listed types of instructions, or any other physical activity for which instructions are useful could be substituted for golf.

In traditional one-on-one instructional events, a person seeking professional instruction is expected to search for instructors, call to make an appointment, drive to the location where the lesson is to be given, wait for the instructor to become available, get the lesson, drive back to the departure location or to their home. Then, if the student (or any other user) wants to retain or review the lesson content, he or she is expected to take notes, or copy of the actual lesson on video with voice instruction overlay.

In many instances the instructions that are provided do not include lesson notes, voice recording, or a video recording, and these may be difficult to obtain. Often the user is left with their memory of what the instructor delivered, or the user is encouraged to practice what they learned and to return for another lesson. In an embodiment, the instruction system 100 may be include several technical components and processes described below, which may have specific dependencies on one another.

Instruction stations 102a-l may be kiosks, which may be located in any of a number of locations. There may be any number of instruction stations 102a-l, which may be stand-alone instruction stations that may be operated independently of the rest of instruction system 100. In an embodiment, instruction stations 102a-l may provide instructions and process prompts to users in a particular subject matter (e.g., golf). In an embodiment, a user may purchase, lease, or rent one or more of instruction stations 102a-l.

In an embodiment, instruction stations 102a-l may be accessed by students at any time that the manager (e.g., franchisee) of a given one or more of instruction stations 102a-i makes the instruction stations available. A student may enter one of instruction stations 102a-i view instructions from an instructor, which may be general instructions and/or instructions tailored for the individual student currently accessing the instruction station. Additionally, the student may be able to practice the lesson being taught or other aspects of the activity of interest. The student may be provided with recording and/or video equipment for recording and/or video copying a practice session so that an instructor may review (e.g., view and/or hear) the activity of interest and make suggestions for improvements. Instruction stations 102a-l may also provide information related to purchasing goods and/or services related to the activity of interest. In an embodiment, instruction stations 102a-l may also be used by instructors to record a preferred manner to perform one or more aspects of the activity of interest for the benefit of the student and/or other lessons.

By providing instruction stations 102a-l that may be accessed by students without the instructor being present and by then providing a recording of the student's practice session that may be reviewed by the instructor without the student being present, issues associated with time commitments required by both the instructor and the student may be reduced. In other words, by using instruction system 100 contact between instructors and learners may be separated, thereby facilitating making the time required to instruct and the time required to be instructed more efficient and more time sensitive than were the instructor and student required to be at the same location at a given time.

Instruction stations 102a-l may be placed on one or more paths that are expected to be used by people that make up the market of interest. For example, in an embodiment in which instruction stations 102a-i provide golf instructions, instruction stations 102a-l may be located at one or more shopping malls, at the user's home (or at one or more of the user's homes), at one or more sporting goods stores that sell golf equipment, and/or at one or more facilities associated with golf courses. Instruction stations 102a-l may be connected to an Internet based network of instructors and experts in many related and ancillary fields. Using instruction stations 102a-l, an individual seeking instructions may receive instructions wherever and whenever instruction stations 102a-i are available, which potentially could be anywhere in the world and any time of day, depending on the distribution of instruction stations 102a-l and the manner in which instruction stations 102a-l are set up.

In an embodiment, since instruction stations 102a-l are already located along user pathways, the user of one of instruction stations 102a-i does not need to invest the time and expense of setting up complicated remote or home video capture hardware and software systems that may not produce consistent, high quality video files with proper lighting and shutter speeds. In an embodiment, instruction stations 102a-i are automated, self service, and may therefore provide a relatively “fail safe,” controlled environment for recording a practice session. In other words, since the equipment is already set up and properly configured inside of instruction stations 102a-l, there is a less of a likelihood of error than were the user required to set up the recording equipment without any aided. In another embodiment, instruction stations 102a-i are accompanied with an assistant to help the user operate the instruction station. For example, there may be several instruction stations 102a-l at a site attended by one assistant.

The system of instruction stations 102a-l may enable users (e.g., consumers, students, instructors, and/or vendors) to acquire and communicate instructions, related services, news, current events, products, and product information. Additionally, or alternatively, instruction stations 102a-l may be used for exchanging important data and information about one user to the other users (e.g., network members, providers of instructions, providers of services, providers of products, and providers of other related equipment). Each of instruction stations 102a-l may have a unique Internet Protocol (IP) address enabling the displaying and/or playing of promotional material on monitors attached to instruction stations 102a-l.

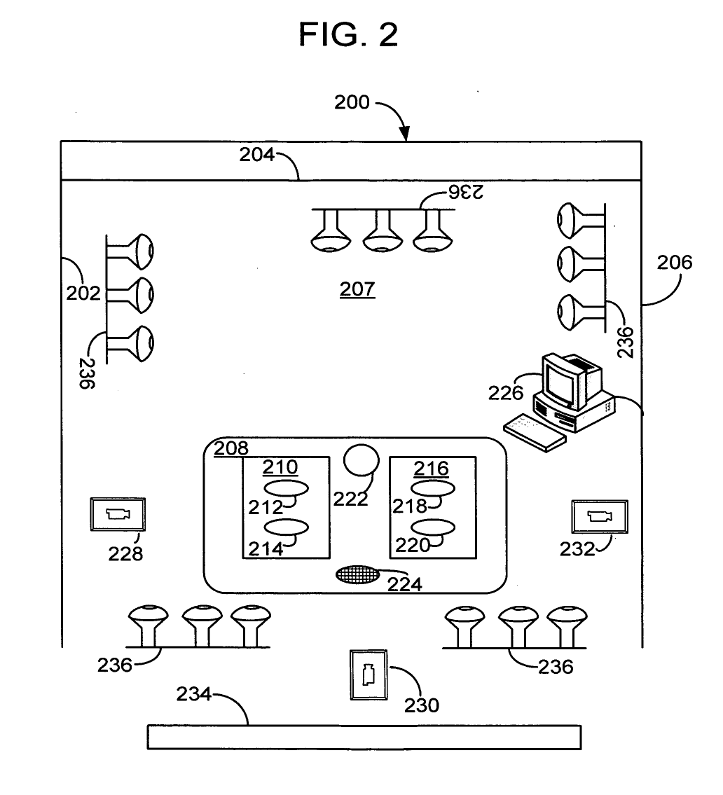

In an embodiment, in addition to instruction stations 102a-l being available any time (or even if instruction stations 102a-l are not available any time), the video based instructions may be available 24 hours a day, 7 days a week, year-round wherever and whenever the user has access to their own private web portal on the internet (and/or an instruction station). Since the instructions are video based, there is no need to try to remember the instructions given by the instructor or the context in which the instructions were given. Any given one of instruction stations 102a-l (possibly each of instruction stations 102a-l) may be equipped with proprietary software that automates the video, audio, and/or other ancillary data capture processes. In an embodiment, instruction stations 102a-l may provide a high quality video, which may include voice comments, coaching, and drills described by a professional teacher. Instruction stations 102a-l will be discussed further in conjunction with FIG. 2.

Server system 104 may manage instruction system 100. Server system 104 may be a computing entity (which may be hardware and/or software) that provides services to other computing entities, which are instruction stations 102a-l, the student network appliances, the instructor network appliances, franchisee network appliances, and the vendor network appliances. Server system 104 may include one or more servers, and different servers within server system 104 may have different functions. Server system 104 may control the downloading of advertising material, lessons, individualized instructions and/or other messages to instruction stations 102a-l, and/or the uploading of purchase orders, practice sessions, and/or other messages from instruction stations 102a-l.

Server system 104 may provide one or more network portals. Network portals are sites on a network that may provide personalized capabilities to their visitors. Network portals may facilitate use of distributed applications, different numbers and types of middleware, and hardware to provide services to, and/or from, a number of different sources. In addition, the network portals on server system 104 may facilitate the sharing of work, such as instructions. Server system 104 may provide portals in which the content is accessible on multiple platforms, such as a personal computer, laptop, personal digital assistant, cell phone and/or other network appliance. In this specification, a network appliance is any appliance that is capable of accessing a network. The network portals provided by server system 104 may allow users to exchange messages with one another via e-mail, a message board, student-instructor chat rooms, and/or student-student chat rooms, or by other forms of exchanging messages.

Server system 104 may provide web portals for students to choose instructors, submit their recorded practice sessions to instructors for review, receive new lessons, receive individualized feedback from the instructors, purchase goods or services related to the activity of interest, schedule sessions at a particular instruction station (selected from instruction stations 102a-l), and/or manage their accounts (e.g., pay for instructions and/or use of one of instruction stations 102a-l). Server system 104 may provide a portal for instructors to provide instructions, receive recorded practice sessions, and establish a student-instructor relationship by assigning a student to an instructor. In an embodiment, an instructor may be assigned a recorded practice session to review in response to a request from the instructor to review a recorded practice session. For example, there may be a queue of recorded practice sessions on server system 104, and after the instructor requests a next assignment, server system 104 may select a recorded practice session from the queue (although the selection is in response to a request from the instructor, the selection may be based on the student's preferences, instructor's preferences, and/or the position of the recorded practice session in the queue).

Server system 104 may also provide a portal for vendors (e.g., “ad partners”) to provide information about the goods and/or services that the vendor provides, provide purchase information, and/or provide contact information. Server system 104 will be discussed further in conjunction with FIG. 1B.

Network 106 may be any one or any combination of one or more Local Area Networks (LANs), Wide Area Networks (WANs), wireless networks, telephone networks, and/or other networks. Instruction stations 102a-l and server system 104 may communicate with one another via network 106. Other devices may also communicate with instruction stations 102a-i and server system 104 via network 106. For example, students, instructors, and/or vendors may transfer (e.g., download and/or upload) information from, and/or to, instruction stations 102a-l and/or server system 104. Some examples of information that may be transferred via network 106 are lessons, videos of practice sessions and/or purchase information related to products and/or services associated with instruction stations 102a-l.

Student network appliances 108a-m may be any appliance used by students connecting to server system 104 and/or instruction stations 102a-l. For example, student network appliances 108a-m may include any combination of personal computers, laptops, handheld computing devices, wireless phones, telephones, text messaging devices, and/or dedicated terminals. In an embodiment, a student may use one of student network appliances 108a-m to download, via network 106, images of a recorded practice session stored at server system 104 that were earlier recorded at one of instruction stations 102a-l, and/or the student may download images of the practice session directly from instruction stations 102a-l and optionally review the images. The student may then send instructions from one of student network appliances 108a-m, via network 106, to server system 104 to forward the images from server system 104, via network 106, to an instructor for comments. Alternatively, the student may send instructions from one of student network appliances 108a-m, via network 106, to directly to one of instruction stations 102a-l to send a recorded practice session to an instructor for comments. Similarly, a student may use one of student network appliances 108a-m to order and/or purchase goods and/or services from a vendor.

Instructor network appliances 110a-n may be any appliance used by instructors for connecting to server system 104 and/or student network appliances 108a-m. For example, instructor network appliances 110a-n may be the same types of appliances as student network appliances 108a-m. However, whereas student network appliances 108a-m are used by students, instructor network appliances 110a-n are used by instructors.

In an embodiment, an instructor may use one of instructor network appliances 1110a-n to receive an assignment including a recorded practice session to review. For example, there may be a queue of recorded practice sessions on server system 104. An instructor may request a next assignment via one of network appliances 110a-n, and in response server system 104 may select one or more recorded practice session from the queue and assign the recorded practice sessions to the instructor making the request. The instructor may then download, via network 106, images of the recorded practice sessions selected. The recorded practice sessions may be downloaded from server system 104, and/or the instructor may download images of the practice session directly from instruction stations 102a-l via network 106 to one of instructor network appliances 110a-n. After reviewing the practice session, the instructor may use one of instructor network appliances 1110a-n to send comments via network 106 about the practice session and/or send a new lesson to server system 104 to be forwarded to one of instruction stations 102a-l and/or to one of student network appliances 108a-m.

There are many different possible criteria and/or priorities that may be used for assigning an instructor to review a recorded practice session. Different sets of criteria and/or priorities may be used in different embodiments. In many embodiments, the user does not need to spend time researching, evaluating, and seeking out professional instructors and/or other experts, because instructors and/or other experts have been pre-selected. Since the instructor and student do not need to be at the same location, instructors may be assigned according to the expertise of the instructor instead of being limited to instructors of a specific locality. In another embodiment, the instructors and/or other experts are available on a local, regional, and/or expertise basis at instruction stations 102a-l most convenient to the instructor, expert, and/or the user (which may be self service and semi-private). In another embodiment, the user is allowed to select an instructor, either from a list of instructors available at instruction stations 102a-l or at a website and/or from other instructors. In an embodiment, since instruction stations 102a-l are located in convenient locations for the user, the user does not necessarily need to drive to and from a remote facility or location to meet up with an instructor to receive a one-on-one instructional teaching session.

In an embodiment, server system 104 makes available at student network appliances 108a-m links, tools, and/or other aids for contacting professional instructors and related physical consultants via a number of communication methods, such as instant messaging, chat sessions, streaming conferences, e-mail accounts, and/or instructor web portals, which may be accessible through one or more Internet based web portals. Similarly, server system 104 may make available a corresponding set of links, tools, and/or other aids at instructor network appliances 110a-n for responding to inquiries from students. In an embodiment, anyone connected to network 106 may access and “stream” audio and video files from one or more of several primary process servers associated with server system 104, via network 106, and consequently there is less need (possibly no need) to store very large videos and/or instructional files on a local/client computer.

Vendor network appliances 112a-o may be used by the vendors for connecting to network 106. In an embodiment, the vendors may be manufacturers who build and supply tools and equipment related to the instructions provided that are allowed to promote their goods and services and purchase sanitized data about those seeking instructions. Sanitized data is statistical data and/or other data from which information ordinarily used to identify a specific person has been removed. Vendor network appliances 112a-o may be used for sending product information, via network 106, to server system 104 for forwarding product and/or service information to one or more of instruction stations 102a-l. Alternatively, vendor network appliances 112a-o may be used by the vendors for sending product information, via network 106, to one or more student network appliances 108a-m and/or one or more of instructor network appliances 110a-n. Sending “promotional” opportunities may involve the transfer and scheduling of many forms of multimedia to one or more of instruction stations 102a-l.

The vendors partnering with instruction system 100 may be from a variety of types of vendors, such as sports goods, beverages, foods, snacks, pharmaceuticals, cars, financial services, phone services, computer vendors, and network services. Some examples of possible vendors are Nike, Coke, Advil, Buick, Adams, Schwab, Cingular, Titleist, ESPN, and Dell.

Instruction system 100 may offer a number of different forms of advertisements to vendors. In an embodiment, instruction system 100 offers advertising space on monitors in instruction stations 102a-l, such as full screen videos and/or banner ads. In an embodiment, in addition to, or instead of, the advertising space within each of instruction stations 102a-l, banners on student and/or instructor portals may also be offered for a vendor to purchase. The banners and/or other advertisements may include links for purchasing the product being sold. Other Points Of Sale (POS) may also be provided. Instruction system 100 may include media portals that facilitate the transmission of any form of electronic media by vendors to instruction stations 102a-l, which may be attached by network 106 (e.g., by internet connections) to communications networks associated with instruction system 100 located anywhere in the world. A student may use one of student network appliances 108a-m to purchase goods and/or services from a vendor.

In an embodiment, each of the franchisees associated with franchisee network appliances 114a-p may own and/or manage one or more of instruction stations 102a-l. Franchisee network appliances 114a-p may be used to determine access policies for their respective instruction stations 102a-l, the price of using their respective instruction stations 102a-l, and/or the price per lesson or range of prices for lessons at their respective instruction stations 102a-l. Franchisee network appliances 114a-p may facilitate monitoring revenues, overseeing transactions involving vendors advertising on the franchisees' instruction stations, overseeing the collection of money from the students and/or the payment of the instructors.

FIG. 1B shows a block diagram of an embodiment of server system 104 in combination with network 106. Server system 104 may include web servers 152a-q, media servers 154a-r, and administrative server system 156. In other embodiments, server system 104 may not include all of the components listed above and/or may include other components in addition to or instead of the components listed above.

Web servers 152a-q may serve web pages related to instruction system 100 and recorded practice sessions. Media servers 154a-r may serve media files to instruction stations 102a-l. There may be any number of web servers 152a-q and/or media servers 154a-r, including just one, two, or three, for example. Media servers 154a-r download the media files and schedules to appropriate instruction stations 102a-l (FIG. 1A). The downloading of the media files and schedules may occur at times when usage of instruction stations 102a-l is low or when instruction stations 102a-l are unused such as during the night time. In an embodiment, the media files that relate to advertisements are uploaded after the lessons and any other swing videos have been uploaded to administrative server system 156. The following day, based on a run scheduler, all new media files will begin playing through one or more of the monitors in instruction stations 102a-l based on ad preference and sequences set by the vendor and/or franchisee in the run scheduler.

Administrative server system 156 manages instruction stations 102a-l. For example, administrative servers 156 may send software updates and/or product information updates to instruction stations 102a-l. Administrative server system 156 may monitor and/or poll the use of instruction stations 102a-l and the media files played at instruction stations 102a-l. Administrative server system 156 and media servers 154a-r may carry out various sets of instructions to perform various tasks based on input received as a result of accessing instructor portals, student portals, vendor portals, and/or franchisee portals on web servers 152a-q. Although there is only one server illustrated in FIG. 1B for administrative server system 156, administrative server system 156 may include one server or may include multiple servers.

Administrative server system 156 may upload a practice session from instruction stations 102a-l. After an upload from instruction station 200 has occurred and all unique, subject specific data folders and data sets have reached administrative server system 156, administrative server system 156 may perform a number of tasks, such as sending e-mails or other forms of messages to users, instructors, vendors, and/or franchisees. In an embodiment, a user portal may be set up on one or more of web servers 152a-q, via which a copy of the recorded practice session (e.g., the original video files along with other data captured) at one or more of instruction stations 102a-l is accessible from administrative server system 156. For example, using the user portal, the user may click on one or more specific links to the data captured in order to cause the data captured to be played or presented. In an embodiment, if the user selected a specific instructor by name, the recorded practice session and data files may be sent by administrative server system 156 to that instructor's recorded practice session queue for subsequent annotation and/or lesson presentation. An e-mail may be sent by administrative server system 156 to the user confirming the selection of the instructor, and optionally the instructor's electronic resume and profile may also be confirmed and/or sent to the user. Similarly, an e-mail may be sent by administrative server system 156 to the instructor announcing that the instructor was selected. Alternatively, the instructor may be informed by administrative server system 156 about where to find the recorded practice session files instead of actually being sent the recorded practice session files.

When the instructor completes the annotation process and sends the completed lesson to administrative server system 156, the user may get another e-mail from administrative server system 156 informing the user that the lesson is ready for viewing, that a new user name is available, and informing the user of a temporary password for accessing the lesson.

If the student did not select a specific instructor, the user's recorded practice session and other data is sent to a “general” queue maintained by administrative server system 156. The general queue may be a queue where any number of instructors may request the recorded practice session as the next practice session and data folder to be downloaded for subsequent annotation and lesson presentation, or a queue where all the practice sessions may potentially be assigned to any instructor that does not refuse to review the practice session and other associated data. In an alternative embodiment, if a user does not request a “lesson” at one of instruction stations 102a-q, the user's recorded practice session and other captured data is not sent to any instructional queue. Instead, the recorded practice session or link to the recorded practice session may be sent by administrative server system 156 to the user's portal on one or more of web servers 152a-q and may be available for future uses, personal enjoyment, and/or for later forwarding to an instructor to review or for forwarding for review by other sports consultants and/or other consultants. In an embodiment, the user's portal may be personal and secure, and consequently, the practice sessions stored at the user's portal are not subject to being viewed by instructors or others unless the user grants access to the instructors or others.

In an embodiment, the user may go to his or her portal (which in an embodiment is private) on one or more web servers 152a-q, at any time view any of his or her lessons, recorded practice sessions, and any related data that are stored in association the user's portal on administrative server system 156, assuming that the user is able to connect to network 106 or to another network at which the user's portal may be available.

Additionally, or alternatively, the user may access their portal on one or more of web servers 152a-q, via administrative server system 156. At the user's portal, the user may purchase any number of consulting services available and/or may access any of the videos stored (the videos may be stored in a database in association with unique identifiers).

FIG. 1C shows a block diagram illustrating some of the communication paths that may be used in instruction system 100. FIG. 1C shows administrative server system 156 communicating via communication path 172 with instruction stations 102a-l, which in turn communicates via communication path 174 with web servers 152a-q, which in turn communicate via communication path 176 with instructor network appliances 110a-n, communicate via communication path 178 with student network appliances 108a-m, and communicate via communication path 180 with franchisee network appliances 114a-p.

Each of communication paths 172, 174, 176, 178, and 180 is a pathway along which messages are sent through network 106. Communication path 172 may be used for sending updates from administrative server system 156 and instruction stations 102a-l and for monitoring and managing instruction stations 102a-l, via administrative server system 156. For each communication path to web servers 152a-q there may be a corresponding communication path to administrative server system 156 and between web servers 152a-q and administrative server system 156. For example, in a place where only a communication path between a user's network appliance and web servers 152a-q is depicted in FIG. 1C, the communication path may represent that when the user accesses a portal on one or more of web servers 152a-q, some information may be sent to one or more of web servers 152a-q via the portal, and the information may then be relayed to administrative server system 156 (despite no direct communication path between being explicitly shown between web servers 152a-q and administrative server system 156), which causes administrative server system 156 to perform a corresponding task.

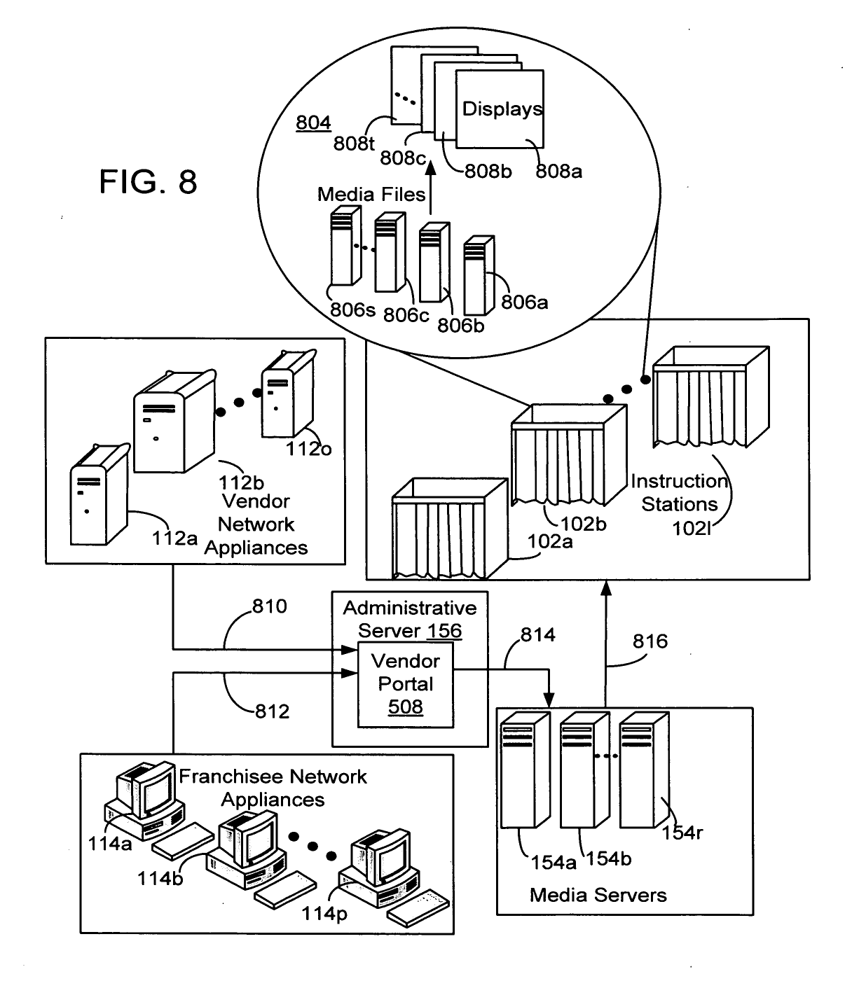

Thus, communication path 174 may be used for communicating with web servers 152a-q regarding uploading recorded practice sessions to administrative server system 156. Similarly, communication path 176 may be used for communicating with web servers 152a-q regarding downloading practice sessions from a server of administrative server system 156 to one or more of instructor network appliances 110a-n. Communication path 176 may also be used for communicating with web servers 152a-q regarding uploading information to administrative server system 156 about an instructor, providing web pages through which instructor network appliances 110a-n may communicate with students. Communication path 178 may be used for providing web pages to student network appliances 108a-m that may be used for communicating with instructors and/or for receiving information from administrative server system 156, media servers 154a-r (FIG. 1B), and/or vendor network appliances 112a-o about a product and/or for purchasing a product. Communication path 180 may be used for sending web pages from web server 152a-q to franchisee network appliances 114a-p, which may be used for entering communications that facilitate the managing instruction stations 102a-l by administrative server system 156. For example, web server 152a-q may send (via communication path 180) to franchisee network appliances 114a-p information relating to promotions, schedules for uploading and/or downloading information to/from instruction stations 102a-l from/to administrative server system 156. Communications through network 106 related to vendor network appliances 112a-o and other communications related to franchisee network appliances 114a-p are discussed in connection with FIG. 8.

FIG. 2 shows an example of an instruction station 200. Instruction station 200 may include wall 202, screen 204, wall 206, interior 207, launch pad 208 having right handed zone 210, which in turn has left foot position 212 and right foot position 214. Launch pad 208 also has left handed zone 216, which in turn has right foot position 218 and left foot position 220. Instruction station 200 also has ball 222. Launch pad 208 also has microphone 224. Instruction station 200 may also include console 226, left camera 228, back camera 230, right camera 232, display 234, and lights 236. In other embodiments, instruction station 200 may not include all of the components listed above and/or may include other components in addition to or instead of the components listed above.

Instruction station 200 is an example of one of instruction stations 102a-l. Wall 202, screen 204, and wall 206 may catch a ball after the ball has been hit by a student. Walls 202 and 206 may also form walls of instruction station 200. Screen 204, and optionally walls 202 and 206, may include one or more nets for catching a ball. In an embodiment, screen 204 and/or walls 202 and 206 may have images projected upon them that may be viewed while recording a practice session, for example. Interior 207 is the interior of instruction stations 200. Launch pad 208 may be used by a student to stand and swing at a ball.

Right handed zone 210 may be used by a right handed hitter to swing at a ball. Left foot position 212 is a marking on right handed zone 210 for the student to place the user's left foot while swinging at a ball. Right foot position 214 is a marking on right handed zone 210 for the student to place the user's right foot while swinging at a ball.

Left handed zone 216 may be used by a left handed hitter to swing at a ball. Right foot position 218 is a marking on left handed zone 216 for the student to place the user's right foot while swinging at a ball. Left foot position 220 is a marking on left handed zone 216 for the student to place the user's left foot while swinging at a ball. In an embodiment, ball 222 may be a golf ball that the user hits towards screen 204. In an alternative embodiment, ball 222 is a marking on launch pad 208 indicating that the user should swing as if there were an actual ball at the position marked by ball 222. Although, in the above description, the nets on wall 202, screen 204, and wall 206, launch pad 208 and ball 222 may relate to golf, in other embodiments one or more of these items may removed, replaced, and/or modified as appropriate for providing instructions for another activity. For example, instead of launch pad 208 and ball 222, interior 207 may be equipped with a hoop for basket ball, artificial rocks for rock climbing, an automatic pitcher for baseball, or a piano (with cameras that track the finger and/or arm positions) for piano lessons. Additionally, the dimensions of any given one of, or combination of, instruction stations 102a-l may be different depending on the activity for which that particular instruction station was intended.

Microphone 224 records the sounds associated with swinging at and/or hitting a ball. The sound of the golf club hitting the ball and/or the ball hitting screen, 204, wall 202, or wall 206 may be used to determine the beginning and/or the ending of a recording of a student swinging at a ball. Initially, a student's entire session may be recorded, and then portions that do not include the student swinging at or hitting ball 222 are removed. The portions that include the swinging may be identified by the sound of the golf club hitting the ball. For example, one or more time periods may be identified that begin a specified amount of time before the golf club hits the ball and end a specified amount of time after the golf club hits the ball. Sections of the recording outside of these one or more time periods may be deleted. Microphone 224 may support communications with a multimedia card (e.g., a firewire card) of a console.

Console 226 may store the recording of the instruction session and edit the recording to remove sections of the recording that are not associated with the swinging of the golf club. Console 226 may play lessons and other messages from an instructor while the student is swinging the golf club, before swinging the golf club, and/or after swinging the golf club. Console 226 may also play messages from vendors, related to product and services that may be purchased. Console 226 may play the practice session recorded. Console 226 may control the lighting (it may be desirable to use different lighting depending upon which cameras are in use and/or the position of the user).

A user (e.g., a student, subject, or other user) may initiate the capture process by interfacing with a touch screen monitor of console 226 mounted in instruction station 200. The user may be programmatically “pulled” through the data entry and subject survey process. In other embodiments, one or more buttons, switches, voice recognition modules, mice, track balls, touch pads, and/or keyboards may be provided with console 226 instead of, or in addition to, the touch screen.

Left camera 228, back camera 230, and right camera 232 record the student during a practice session. Left camera 228, back camera 230, and right camera 232 may capture a frontal orientation for right and left handed subjects and may provide a rear and down-line view.

Specifically, if the student uses right handed zone 210, left camera 228 records the back of the student while camera 232 records the front of the student when the student swings at the ball (and back camera 230 provides a side view of the student, which is a rear down-line view of the golf ball). If the student uses left handed zone 216, left camera 228 records the front of the student while right camera 232 records the back of the student when the student swings at the ball (and again back camera 230 provides a side view of the student, which is a rear down-line view of the golf ball).

Depending on the embodiment, the student may use all three cameras, just two of the cameras, or just one of the cameras to record the practice session. In an embodiment, if only two cameras are used, back camera 230 and the one of right camera 232 and left camera 228 that is in front of the student may be used to record the practice session. In an embodiment, if only one camera may be used, the back camera 230 may be used to record the practice session. In another embodiment, if only one camera may be used, the one of right camera 232 and left camera 228 that is in front of the student may be used to record the practice session. In another embodiment, the student may be given a choice as to which cameras to use. In another embodiment, there may be more cameras, fewer cameras, and/or the cameras may have different locations within instruction station 200. For example, there may be a camera in the vicinity of screen 204 and/or in one or more of the corners of instruction station 200. In an embodiment, left camera 228, back camera 230, and right camera 232 are digital video cameras that support communications with a console having a multimedia card, such as a firewire card.

One or more of left camera 228, back camera 230, and right camera 232 may be mounted at an angle (e.g., a 45 degree angle) to compensate for distance requirements and focal length restrictions. If one or more of left camera 228, back camera 230, and right camera 232 is oriented at an angle, the software at console 226 may alter the images that are produced to compensate for the angle at which the cameras are oriented.

Although instruction station 200 has three cameras, any number of cameras may be used (e.g., one or more) in any given instruction station. Additionally, there may be at least two cameras for capturing synchronized motion depending on right-hand or left-hand orientation. The right-hand or left-hand orientation (and/or other orientations of the user's body and/or of the cameras) may be selected by a subject during a survey answer process, which may be used to position the cameras and/or select which cameras to use.

Console 226 may control and/or receive input from microphone 224, left camera 228, back camera 230, and right camera 232. Optionally, there may be switches and/or other controls for the lights, microphone 224, left camera 228, back camera 230, and right camera 232 that are located outside of console 226 in addition to, or instead of, console 226 being capable of controlling lights, microphone 224, left camera 228, back camera 230, and right camera 332. Microphone 224, left camera 228, back camera 230, and right camera 232 may support communications with a multimedia card (e.g., a firewire card) of console 226.

Image capture software components in console 226 may manage all otherwise typical and necessary human interaction including (but not limited to) on/off switches, lights 236, right camera 228, back camera 230, left camera 232, and/or other peripheral devices. The instructions sent as a result of the image capture software components being implemented may be based on specific responses to survey questions and/or on which combination of buttons, menu options, and/or switches are activated. The software may timestamp one or more significant events, such ball impacts (e.g., 10 ball impacts) based on decibel detection from microphone 224 or other microphones, pressure sensors, gravitometers, motion sensors, and/or light sensors (that detect changes in light caused by the trajectory of the ball). Other examples of possible significant events relevant to other activities and/or embodiments are a ball bouncing on the floor, certain placements of feet, and/or certain placements of hands such as on a bat, club, or artificial rock formation.

Display 234 may display the messages and/or practice sessions being played by console 226. Display 234 may be controlled by console 226. Display 234 may be a flat panel display or another display, and may be capable of handling streaming video. Display 234 may support communications with a multimedia card (e.g., a firewire card) of console 226.

Lights 236 may illuminate instruction station 200. In one embodiment, lights 236 may include at least two bays of lights, which may be a right-hand and a left-hand oriented bay of lights directed on the user for illumination while capturing a video. In another embodiment, lights 236 may include multiple bays of lights placed in a variety of locations in instruction station 200. A particular bay of lights may be turned on or off depending on whether the user swings (or in other embodiments performs other activities, such as throwing, kicking, or hitting) with a right-handed or left-handed orientation. Which of lights 236 are selected may be based on a survey answer process and/or sensors sensing the position of the user. In an alternative embodiment, ambient lighting or natural light shining through a sun roof and/or windows may be used for lighting instruction station 200 while capturing videos of a user.

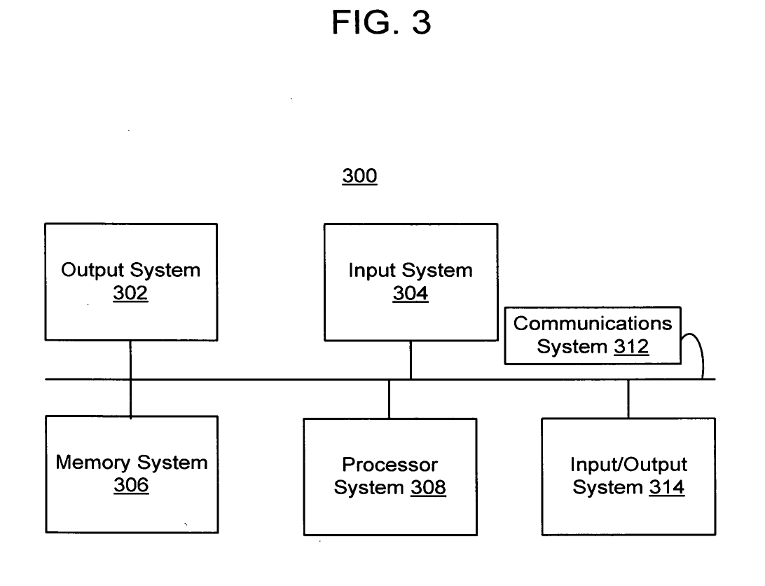

FIG. 3 shows a block diagram of a machine 300 used in FIGS. 1 and 2. The machine may include output system 302, input system 304, memory system 306, processor system 308, communications system 312, and input/output system 314. In other embodiments, machine 300 may not include all of the components listed above and/or may include other components in addition to or instead of the components listed above.

Machine 300 is an example of a machine that may be used for any one of, any combination of, or all of console 200, server system 104, student network appliances 108a-m, instructor network appliances 110a-n, and vendor network appliances 112a-o.

Output system 302 may include any one of, some of, any combination of, or all of a monitor system, a handheld display system, a printer system, a speaker system, a connection or interface system to a sound system, an interface system to peripheral devices and/or a connection and/or interface system to a computer system, intranet, and/or internet, for example. Output system 302 may support broadband communications.

Input system 304 may include any one of, some of, any combination of, or all of a keyboard system, a mouse system, a track ball system, a track pad system, buttons on a handheld system, a scanner system, a microphone system, a connection to a sound system, and/or a connection and/or interface system to a computer system, intranet, and/or internet (e.g., IrDA, USB), for example. Input system 304 may support broadband communications. Input system 304 may include a card reader.

Memory system 306 may include, any one of, some of, any combination of, or all of a long term storage system, such as a hard drive; a short term storage system, such as random access memory; a removable storage system, such as a floppy drive or a removable drive; and/or flash memory; for example. Memory system 306 may include one or more machine readable mediums that may store a variety of different types of information. The term machine-readable medium may be used to refer to any medium capable carrying information that is readable by a machine. One example of a machine-readable medium is a computer-readable medium. Another example of a machine-readable medium is paper having holes that are detected that trigger different mechanical, electrical, and/or logic responses. The term machine-readable medium also includes mediums that carry information while the information that is in transit from one location to another, such as copper wire and/or optical fiber.

Processor system 308 may include any one of, some of, any combination of, or all of multiple parallel processors, a single processor, a system of processors having one or more central processors and/or one or more specialized processors dedicated to specific tasks. Processor system 308 may include a multimedia card for communicating with multimedia equipment. For example, in an embodiment, machine 300 supports the IEEE 1394b standard, and processor system 308 may include a cross-platform implementation of a high-speed serial data bus, defined by the IEEE 1394-1995, IEEE 1394a-2000, and IEEE 1394b standards, that can move large amounts of data between computers and peripheral devices, such as a firewire card, having transfer speeds of up to 800 megabits per second. Using the multimedia card, processor system 308 may communicate via output system 302 and input system 304 with microphone 224, console 226, left camera 228, back camera 230, right camera 232, display 234, and/or lights 236.

Communications system 312 communicatively links output system 302, input system 304, memory system 306, processor system 308, and/or input/output system 314 to each other. Communications system 312 may include any one of, some of, any combination of, or all of electrical cables, fiber optic cables, and/or means of sending signals through air or water (e.g., wireless communications), or the like. Some examples of means of sending signals through air and/or water include systems for transmitting electromagnetic waves such as infrared and/or radio waves and/or systems for sending sound waves.

Input/output system 314 may include devices that have the dual function as input and output devices. For example, input/output system 314 may include one or more touch sensitive screens, which display an image and therefore are an output device and accept input when the screens are pressed by a finger or stylus, for example. The touch sensitive screens may be sensitive to heat and/or pressure. For example, in an embodiment, console 226 includes a touch screen. One or more of the input/output devices may be sensitive to a voltage or current produced by a stylus, for example. Input/output system 314 is optional, and may be used in addition to or in place of output system 302 and/or input device 304.

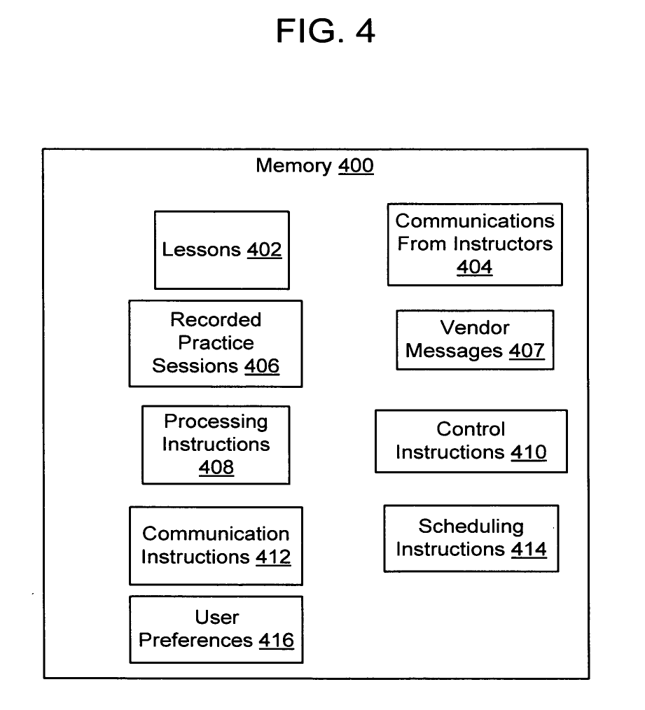

FIG. 4 shows a block diagram of an example of memory 400, which may be used in console 226 (FIG. 2). Memory 400 may store lessons 402, communications from instructors 404, recorded practice sessions 406, vendor messages 407, processing instructions 408, control instructions 410, communication instruction 412, scheduling instructions 414, and user preferences 416. In other embodiments, memory 400 may not store all of the items listed above and/or may store other items in addition to or instead of the components listed above.

Memory 400 is an embodiment of memory system 306 that may be used in console 226 in an embodiment in which console 226 is a machine such as machine 300 (FIGS. 2 and 3). Lessons 402 may include a standard set of lessons that may be used by any student and/or may include individualized lessons prepared by a particular instructor for a particular student. Communications from instructors 404 may include additional communications from a particular instructor to a particular student. Recorded practice sessions 406 may include practice sessions of individual students that the student may want to view or send to an instructor. Recorded practice sessions 406 are discussed further in conjunction with processing instructions 408.

Vendor messages 407 may include messages, such as media files, from various vendors related to products that the student may find useful. One or more of vendor messages 407 may be tailored to the students using the instruction station at which vendor messages 407 are stored. For example, vendor messages 407 may be relevant to a particular level that the student has achieved.

Processing instructions 408 are one or more instructions carried out by console 226 for editing a practice session prior to, in the process of, or after, storing the practice session in recorded practice sessions 406. The content and format of recorded practice sessions 406 may be determined at least in part by processing instructions 408. In an embodiment, there is one timestamp per significant event, such as a golf swing. Processing instructions 408 may cut one or more video segments (e.g., 10 video segments) that start a specified amount of time (e.g., 2 seconds) prior to, and ends a specified amount of time (e.g., 2 seconds) after, each of the timestamps. The one or more video segments may be saved as separate video files of each separate swing (or other significant event), which in an embodiment may be 4 seconds long.

In an embodiment, processing instructions 408 may save recorded practice sessions 406 in a subject specific folder in a temporary directory on a storage device, such as a hard drive, for subsequent processing. In an embodiment, processing instructions 408 may discard any unnecessary video captured during the recording process. For example, in the embodiment in which there is only one timestamp per swing, video footage may be discarded by the software if the footage falls outside of the 4 second windows of all of the time stamps. Although 4 seconds is an example of an appropriate window for a golf swing, other windows may be used for golf swings, and other significant events (e.g., related to other types of sports or other activities) may use other length windows. For some types of activities an entire practice session may be recorded and stored for viewing, or an entire series of actions may be recorded in one long window of several minutes. For some activities although the entire practice session is not necessarily stored, a significant portion of the practice session may be recorded and stored for viewing. Although in the embodiment of FIG. 4 processing instructions 408 is located in memory 400 of console 226 (FIG. 2), in other embodiments processing instructions 408 may be located at server system 104 (FIG. 1A) or at another remote computing device.

Control instructions 410 are one or more instructions for recording a practice session, scheduling the display of various media and/or displaying various media. Control instructions 410 may include one or more instructions for controlling microphone 224, left camera 228, back camera 230, right camera 232, display 234, and/or lights 236 (FIG. 2). Control instructions 410 may determine which of left camera 228, back camera 230, right camera 232, display 234, and/or lights 236 are on and/or off. Control instructions 410 may coordinate the actions of microphone 224, left camera 228, back camera 230, right camera 232, display 234, and/or lights 236 based on keyboard and/or touch screen inputs from the student, motions associated with the student practicing a swing, voice commands from the student, and/or instructions from the instructor.

In an embodiment, control instructions 410 places one or more time stamps on the recorded practice sessions 406 that may be used by processing instructions 408 for removing portions of the recorded practice sessions 406 that are not of interest. In an embodiment, a timestamp is added by control instructions 410 every time microphone 224 records the golf club hitting the ball. In another embodiment, control instructions 410 add a timestamp demarking the beginning of each swing and a corresponding timestamp demarking the end of the swing, based on the sound of the golf club moving through the air and/or an analysis of the images recorded. In another embodiment, the user indicates the beginning of each swing by entering user input (e.g., by pressing a button or uttering a voice command) and indicates the end of each swing by entering more user input, which are recorded by control instructions 410.

Control instructions 410 may schedule when lessons 402, communications from instructors 404, recorded practice sessions 406, and/or vendor messages 407 are displayed. In an embodiment, while files are being downloaded and/or uploaded, control instructions 410 may be scheduling and playing videos and/or other multimedia presentations to a separate monitor, which could be any number of large screen television type monitors or other viewing devices. For example, while the other activities and processes are being performed, a prioritized list of sequenced media files may be scheduled to be displayed on display 234 or on the monitor attached to console 226 or another display (FIG. 2). The media files being scheduled to be played or displayed may contain any subject desired, such as communications from instructors 404, recorded practice sessions 406, vendor messages 407 or any other advertising, instructions, drills, prerecorded events, and/or other subject matter. For example, the media files that control instructions 410 cause to be displayed may be for the purpose of educating and informing anyone in view or within earshot. In an alternative embodiment, media servers 154a-r (FIG. 1B) handle all of the scheduling of the displaying of various media instead of console 226. In this embodiment, media servers 154a-r may prompt console 226 (FIG. 2) just prior to playing a particular media file.

Communications instructions 412 may include one or more instructions for receiving communications from and/or sending communications to a vendor, instructor, student, and/or server system 104. For example, communication instructions 412 may automatically upload recorded practice sessions 406 to server system 104, to student network appliances 108a-m associated with recorded practice sessions 406, and/or to instructor network appliances 110a-n associated with recorded practice sessions 406.

If a user interface at instruction station 200 (FIG. 2) becomes idle (for example, when no one is using instruction station 200 for capturing videos or entering data) communication instructions 412 at instruction station 200 may initiate a process of compressing recorded practice sessions 406 (which may be found in the user specific folders located in the temporary directory). When instruction station 200 is idle, communication instructions 412 may also store the results of the compression along with the all other data captured during the survey entry process and any other data gathered by other peripheral devices in another directory. Thus, there is a temporary directory for storing recorded practice sessions prior to compression and another that stores the compressed recorded practice sessions. The other directory may serve as a holding place for recorded practice session/data capture folders of all users that have participated during a given period. The compression of the recorded practice sessions 406 may facilitate the transfer of recorded practice sessions 406 over network 106, because larger files take longer to transfer and are more likely not to be transferred successfully.

Recorded practice sessions 406, after being compressed, may be uploaded to network 106, and accessed by server system 104. The uploading of recorded practice sessions 406 by communications instructions 412 may occur at a prescheduled time when other network data transfer activity is at a minimum. Alternatively, the recorded practice sessions 406 may be transferred immediately to server system 104, if the connection between console 226 and server system 104 is capable of handling that much data at the time of recording.

Scheduling instructions 414, may include instructions for scheduling the display of media files. User preferences 416 may include the preferences and/or other information gathered by console 226 from the student, which may relate to the manner in which lights 236, right camera 228, back camera 230, and left camera 232 (FIG. 2) are configured. User preferences 416 may include information, such as whether the user is right handed or left handed. Some or all of user preferences 416 may be used for constructing part of all of control instructions 410.

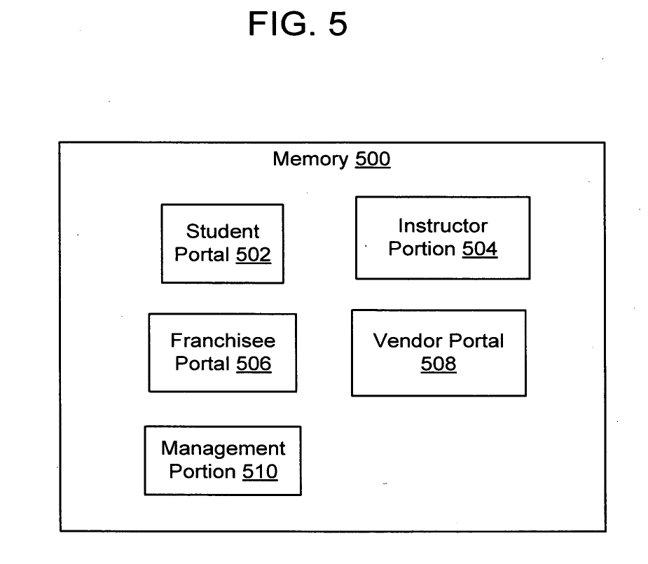

FIG. 5 shows a block diagram of an example of a memory 500. Memory 500 may include student portal 502, instructor portion 504, franchisee portal 506, vendor portal 508, and management portion 510. In other embodiments, memory 500 may not store all of the items listed above and/or may store other items in addition to or instead of the components listed above.

Student portal 502 may be the interface between the student and instruction system 100 (FIG. 1A). Student portal may allow a student to logon to server system 104 (FIG. 1A), acquire membership, check if a lesson has been reviewed, communicate with instructors, purchase products, and/or pay for lessons.

In an embodiment, student portal 502, instructor portion 504, and franchisee portal 506 are each accessible through a browser interface that requires a user name and password for entry. Each portal gives each unique user access to specific content. For example, only students have access to student portal 502, where all of the student's videos reside, such as the recorded practice sessions, the files created from the recorded practice session by the instructor, and the instructor's lessons. Likewise, in an embodiment, all other participants (e.g., the instructor, franchisees, vendors, other media providers, etc.) may have access to only their corresponding portals and/or portions, and each portal and/or portion may have specific data, other content, and tools available to the user once logged in.

In an alternative embodiment, some of the portals may be associated with certain administrative privileges that allow the user of one portal limited access to other user's portals. For example, an instructor may have limited access to the student portals of the students assigned to that instructor, and a franchisee may have limited access to student portals and instructor portions associated with that franchisee.

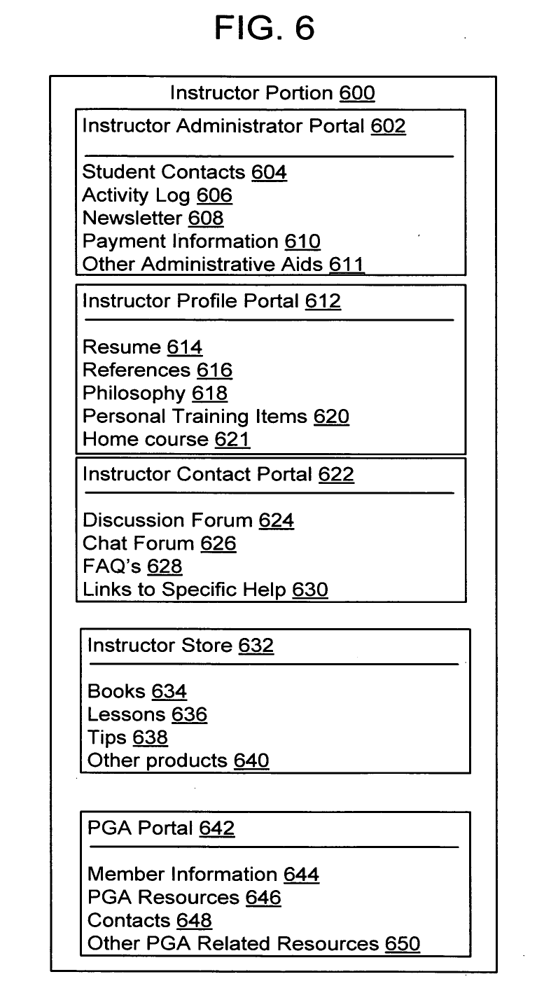

Instructor portion 504 may include an instructor portal and may include tools that the instructor may use to produce video instructions critiquing a student's practice session. Instructor portion 504 may be an interface between the instructor and instruction system 100 (FIG. 1A). Instructor portion 504 will be discussed further in conjunction with FIG. 6.

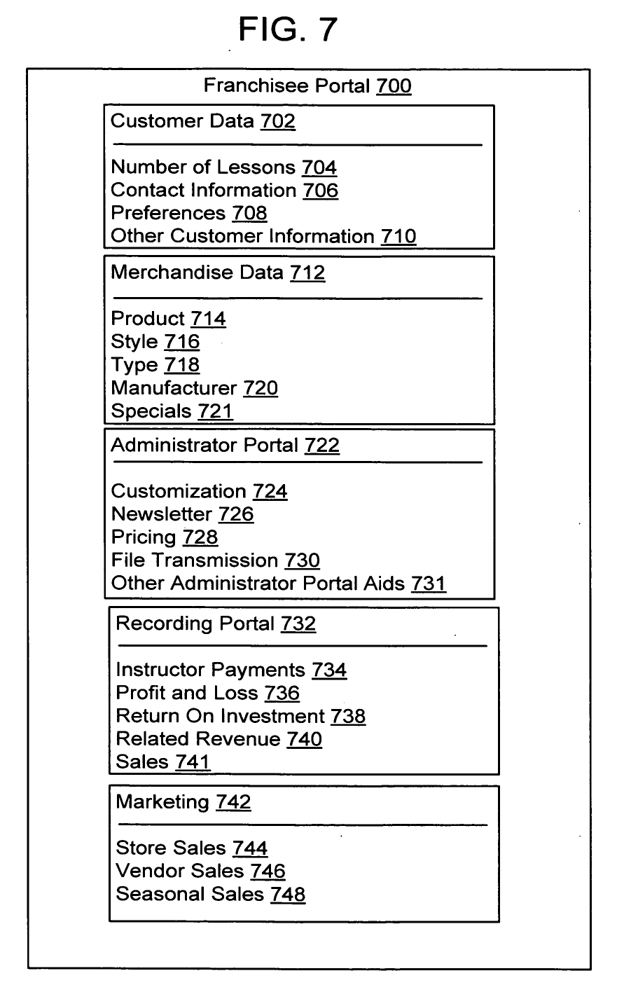

Franchisee portal 506 may serve as an interface between a franchisee and system 100 (FIG. 1A). Franchisee portal 506 may allow the franchisee to monitor profits, revenues, expense, payments by students, payments by or to instructors, merchandise being sold and advertised. Franchisee portal 506 may contain other portals such as a media portal for monitoring and controlling the scheduling of the display of media. Franchisee portal 506 will be discussed further in conjunction with FIG. 7.

Vendor portal 508 may be used by vendors to establish accounts and manage business transactions. Vendor portal 508 may be or may include and/or grant access to a media portal for sending advertisement material and for scheduling the display of the advertisement material. Vendor portal 508 may allow vendors to select regions, Zip codes, or particular ones of instruction stations 102a-l where a particular advertisement will be displayed. Vendor portal 508 also may allow the vendor to select schedules for running advertisements. Vendor portal 508 (e.g., a media portal or via a media portal) may include fields for selecting a media format and/or file for each upload. Vendor portal 508 may allow a vendor to select an upload command (causing an upload to begin) and/or set an upload time for uploading media files that store advertisements. Alternatively, the vendors just send a notification that advertisements are available, and the franchisee, via vendor portal 508, may requests media servers 154a-r (FIG. 1B) to upload the advertisements and schedule their display. As a result of the inputs and settings that were activated via vendor portal 508, media servers 154a-r upload and/or receive the media files, the schedules for when to run advertisements, the markets (e.g., the locations and/or instruction stations) where to run the advertisements.

Management portion 510 may be used by an administrator of server system 104 to manage the workings of the server system 104 and/or instruction system 100 (FIG. 1A). For example, at times it may be necessary to communicate with the franchisees, vendors, students and/or instructors regarding financial matters, and/or the operations of their respective portals. Similarly, management portion 510 may used for performing maintenance, troubleshooting, distributing updates, and/or distributing upgrades to all or part of instruction system 100.

FIG. 6 shows a block diagram of an example of instructor portion 600. Instructor portion 600 may include instructor administrative portal 602, which in turn may include student contacts 604, activity log 606, newsletter 608, payment information 610, and other administrative aids 611. Instructor portion 600 may also include instructor profile portal 612, which in turn may include resume 614, references 616, philosophy 618, personal training items 620, and home course 621. Instructor portion 600 may also include instructor contact portal 622, discussion forum 624, chat forum 626, Frequently Asked Questions (FAQs) 628, and links to specific help 630. Instructor portion 600 may also include instructor store 632, which in turn may include books 634, lessons 636, tips 638, and other products 640. Instructor portion 600 may also include Professional Golfers' Association (PGA) portal 642, which in turn may include member information 644, PGA resources 646, contacts 648, and other PGA related resources 650. In other embodiments, instructor portal 600 may not include all of the elements listed above and/or may include other elements in addition to or instead of the components listed above.

Instructor portion 600 may be an embodiment of instructor portion 504. In an embodiment, instructor portion 600 may be accessed on server system 104 via network 106 by any of instructor network appliances 110a-n (FIG. 1A). An instructor may need to become a member of instruction system 100 (FIG. 1A) prior to making full use of instructor portion 600. Before becoming a member of instruction system 100, the instructor may still be able to access instructor portion 600 in order to become a member. In an object oriented programming environment, each time an instructor access instructor portion 600 another instance of instructor portion 600 may be created that is customized according to the instructor. When the instructor first joins system 100 many of the fields may be empty and/or contain default settings and/or data. As the instructor uses instructor portion 600 the empty fields are filled with the instructions personal information and the default settings are replaced by settings that are specific to the instructor.

Instructor administrative portal 602 may facilitate performing various administrative tasks associated with the instructor. Student contacts 604 may contain contact information of the students that the instructor was assigned to work with. Activity log 606 may include upcoming activities that the instructor may want to participate in and/or may include a log of prior activities associated with the instructor. Newsletter 608 may include information about changes to the services provided to the instructors and/or students and/or general golf news, such as upcoming tournaments and/or the performance of famous players at various tournaments. Payment information 610 may include information related to payments that the instructor may need to make in order to have access to certain services or to maintain membership in system 100. Other administrative aids 611 may include any other information and/or tools to aid the instructor in managing his or her schedule of practice lessons to critique and/or other tasks related to the lessons.

Instructor profile portal 612 may include information about the instructor and/or may be used for posting information about the instructor. The information about the instructor may be stored in a location that is accessible by students to allow the students to choose the instructor assisting them. Alternatively, or additionally, the information about the instructor may be stored in a location that is accessible by the franchisees and/or an administrator of system 100 in order to decide whether to assign certain students and/or tasks to the instructor. Resume 614 may include one or more resumes of the instructor (e.g., in a resume format of the instructor's choosing or in a standardized resume format). The instructor may be able to control which resume is seen by which viewer. Resume 614 may contain information that is not in resume format, but that is the same as, or related to, information that is on a resume or that one would normally put on a resume. For example, resume 614 may include golfing and teaching experience, awards, ratings, tournaments and/or other competitions participated in, and placement in tournaments and/or other competitions in which the instructor participated. References 616 may include letters of recommendation from other professional golf players and/or from students. Philosophy 618 may include a description of the instructors golfing philosophy and/or teaching philosophy. Personal training items 620 may include items that the instructor uses for self training and/or for training students. Home course 621 may include the name and location of the course that the instructor most often plays on. A list of other courses of interest or that are noteworthy that the instructor has played on or that the instructor often plays on may also appear in instructor profile portal 612.

Instructor portion 600 may include various facilities that aid the instructor in giving advice. Contact portal 622 may include an interface via which instructors may send and/or receive communications to and/or from students and/or may include a list of practice sessions for the instructor to review and comment upon. Discussion forum 624 allows the instructor to lead discussions on various aspects of golf, which may be scheduled at regular intervals. Chat forum 626 may include an online chat room that is monitored and/or moderated by the instructor. For example, chat forum 626 may be a chat room in which the participants are students of the instructor, and most of the discussion centers around questions to the instructor and the instructor's answers. FAQ's 628 may include a list of frequently asked questions, which may be posted by the instructor. FAQs 628 may include some question and answer pairs supplied to all instructors to post if they find them helpful and/or may include some question and answer pairs that were written by the instructor. Links to specific help 630 may include links provided by the instructor stored in a location accessible by students. Links to specific help 630 may include links to other websites where the student may find help or may include links to more helpful information provided by and/or written by the instructor for certain types of issues.

Instructor store 632 may include various items that the instructor posts as suggested items to purchase and/or that the instructor recommends purchasing. Instructor store 632 may be another instructor portal specifically for the purpose of making information and products available to his or her students. Instructor store 632 may be created by the instructor and may be available to students to whom the instructor gives access. From instructor store 632, an instructor may build a library of his/her personal video drills, conduct chat sessions, conduct streaming, and real-time golf clinics and provide other golf related services of value to the instructor's students. Books 634 may be books about golf, which may include different books for different levels. Books 634 may include books about techniques for playing golf better, the history of golf, and/or teaching golf (e.g., some students may have questions about teaching certain aspects of golf to their close friends). Lessons 636 may include lessons prepared by the instructor, lessons that the instructor recommends (e.g. “canned” or already prepared lessons) that the instructor may not have actually prepared, and/or methods for teaching golf. Tips 638 may include tips prepared by the instructor for the instructor's students, tips for the instructor to use as part of critiquing a student's practice session and/or general tips not necessarily prepared by the instructor, but that the instructor generally recommends to students. Other products 640 may include other golf related products that the students of the instructor may find useful and/or that the instructor may want the student to purchase.

PGA portal 642 may contain various resources that the instructor may find useful for teaching and/or for maintaining the instructor's knowledge and skills related to golf, which may be available from the PGA. Member information 644 may contain information related to the benefits of being a PGA member. PGA resources 646 may include a list of, and/or links to, various resources available from the PGA. Contacts 648 may include contact information for various PGA officers and other PGA members. Other PGA related resources 650 may include other resources related to the PGA. In other embodiments one or more other organizations may be substituted for the PGA.

FIG. 7 shows a block diagram of an example of a franchisee portal 700. Franchisee portal 700 may include customer data 702, which in turn may include number of lessons 704, contact information 706, preferences 708, and other customer information 710. Franchisee portal 700 may include merchandise data 712, which in turn may include products 714, styles 716, types 718, manufacturer 720, and specials 721. Franchisee portal 700 may include administrator portal 722, which in turn may include customization 724, newsletter 726, pricing 728, file transmission 730, and other administrator portal aids 731. Franchisee portal 700 may include recording portal 732, which in turn may include instructor payments 734, profit and loss 736, return on investment 738, related revenue 740, and sales 741. Franchisee portal 700 may include marketing 742, which in turn may include store sales 744, vendor sales 746, and seasonal sales 748. In other embodiments, franchisee portal 700 may not include all of the elements listed above and/or may store other elements in addition to or instead of the components listed above.

Franchise portal 700 may be an embodiment of franchise portal franchisee portal 506 (FIG. 5). Customer data 702 may include a variety of information about each customer, such as the students. In different embodiments and/or for certain purposes different types of people and/or legal entities may be customers. For example, in some embodiments the instructors may be customers that buy certain products to aid them with keeping at the top of their profession, teaching, preparing comments on recorded practice sessions, composing and/or recording audio-video lessons. Lessons 704 may be lessons that are purchased by a student. Lessons 704 may be recorded lessons that are intended to be purchased by a particular customer. Lessons 704 may also include a complete list of lessons that are available to, and/or recommended for purchase, that have been purchased by any given customer. Some or all of lessons 704 may be prerecorded and available for all students. Different ones of lessons 704 may be recommended for different levels. Some of lessons 704 may be recommended for students having a particular instructor. In an embodiment, instructors may record their own lessons for their students, and these lessons are added to or included within lessons 704. In an embodiment, there may also be lessons for instructors to purchase that relate to teaching techniques.

Contact information 706 may include contact information for each customer, such as a mailing address, a billing address, e-mail address, instant messaging address, website address, phone number, facsimile number, and/or mobile phone number, for example. Preferences 708 may include preferences of the customer for a variety of areas. For example, preferences 708 may include the customer's preferences regarding how the customer is billed or pays bills. Preferences 708 may include a customer's preferences regarding which one or more of instruction stations 102a-l the customer likes to use and/or the times of day that the customer likes to use a particular one or more of instruction stations 102a-l. If the customer is a student, preferences 708 may include preferences that relate to which instructor should review that student's recorded practice sessions. Preferences 708 may include the current level that the student has achieved. Other customer information 710 may include any other customer information not already listed.

Merchandise data 712 may include various items of merchandise that are available to customers for purchase, such as equipment, books, and/or lessons. Merchandise 712 may be accessed by a franchisee to help with decisions related to what other products to offer, projected future sales, and/or to help answer inquiries from customers and/or vendors. Products 714 may include a list of products sold by the franchisee. Styles 716 may include various styles associated with a given one of products 714. For example, if the product is a golf ball, the style may be the color of the golf ball. Types 718 may include a variety of types associated with a particular one of products 714. For example, if the product is a golf club the type may be a putter. If the product comes in different sizes, the different sizes may also be listed and available for purchase. Manufacturers 720 may be the manufacturers and/or other vendors of the products 714. Specials 721 may be various specials that are currently being offered, are planned to be offered, and/or that were offered. Specials 721 may include information related to the length of time and/or specific dates that the specials will be or were available. Specials 721 may include specials available to the customers and/or specials available from the manufacturer to the franchisee.

Administrator portal 722 may be an interface that a franchisee may use to manage various operations relating to instruction system 100 (FIG. 1A). For example, administrator portal 722 may be used by the franchisee for configuring various aspects of one or more of instruction stations 102a-l. Customization 724 may include various settings related to the server system 104 (FIG. 1A), franchisee portal 700, and/or instruction stations 102a-l. Newsletter 726 may be the same as newsletter 608 (FIG. 6). Newsletter 726 may be composed for the franchisee and/or by the franchisor. Newsletter 726 may include information about the chain that runs instruction stations 102a-l, new software available on server system 104 for the franchisee, students, instructors, and/or vendors, upgrades and new features for instruction stations 102a-l, tips for running a franchise, and/or new products that are expected to be available for the franchisee to sell.

Pricing 728 may include one or more aids for setting prices of merchandise and services. Pricing 728 may include the current prices at which each service and/or product is sold, the cost of purchasing the products or services from various vendors, and/or other costs associated with storing and selling each product and/or service. File transmission 730 may include settings for and/or information related to the transmission of files to and from instruction stations 102a-l (FIG. 1), from vendors, and/or between instructors and students. Other administrator portal aids 731 may contain other aids a franchisee to perform various administrative tasks.

Recording portal 732 may be for the franchisee to record financial data and compute financially significant indicators related to the financial health of the franchisee's franchise. Instructor payments 734 may record and/or track payments made to and/or received from an instructor. Profit and loss 736 may compute the profit or losses of an entire franchise and/or individual portions of the franchise, such as the profit and/or loss associated with any particular instructor, product, and/or instruction station associated with the franchisee. Return on investment 738 may compute the return on investment as a percentage of the investment and/or as a dollar amount of an entire franchise and/or individual portions of the franchise, such as the profit and/or loss associated with any particular instructor, product, and/or instruction station associated with the franchisee. Related revenue 740 may be used for recording and/or automatically tracking revenue from sources related to instruction stations 102a-l (FIG. 1A), such as from advertisements and sales of products purchased by the franchisee, but which may be ancillary to the franchise, such as snacks sold by the franchisee at an instruction station. Sales 741 may allow a franchisee to record and/or track sales of instructions, use of instruction stations, equipment, lessons, and/or tools for preparing lessons, for example.

Marketing 742 may aid the franchisee in controlling the marketing and/or tracking the marketing of various items and services associated with those of instruction stations 102a-l run by the franchisee. Marketing 742 may include tools for composing advertisements. Store sales 744 may allow the franchisee to set, compose, and/or monitor the sales that will be offered in relation to items sold by the franchisee, such as equipment. Vendor sales 746 may provide the franchisee with information about promotions offered by vendors to students, instructors, and/or the franchisee manufacture. Regarding sales offered to the students and instructors, the franchisee may be given tools for composing and/or editing the advertisement, modifying the sales price and/or duration of the sale. Seasonal sales 748 may include tools for setting, composing, and/or viewing information about sales that are set according to the time of year.

FIG. 8 shows a block diagram of the flow of information in managing advertisements. FIG. 8 shows vendor network appliances 112a-o, franchisee network appliances 114a-p, administrative server system 156 having vendor portal 508, media servers 154a-r, instruction stations 102a-l, blowup 804 having media files 806a-s, displays 808a-t, and communication paths 810, 812, 814, and 816.

Instruction stations 102a-l, vendor network appliances 112a-o, and franchisee network appliances 114a-p were discussed in FIG. 1A. Administrative server system 156 and media servers 154a-r were discussed in FIG. 1B, and vendor portal 508 was discussed in FIG. 5. Blowup 804 shows a representation of various occurrences within instruction stations 102a-l according to one embodiment. Media files 806a-s store various advertisements and product information. Different groups of media files 806a-s may be associated with different instruction stations 102a-l. The console of each of instruction stations 102a-l may store a different copy of some of media files 806a-s, and some of media files 806a-s may only be stored at particular ones of instruction stations 102a-l. Each of displays 808a-t may be an embodiment of display 234 (FIG. 2). Each of displays 808a-t may be associated with a different one of instruction stations 102a-l. Communication paths 810, 812, 814, and 816 may be different paths via which messages are sent through network 106 or through another network or direct connection. Ad partners using browsers on vendor network appliances 112a-o, via communication path 810, log into vendor portal 508 (which may include an advertisement portal for uploading advertisements and for requesting the display of advertisements).

In one embodiment, media files are uploaded to media servers 154a-r and streamed across a high-quality, high-speed internet connection directly to instruction stations 102a-l where a media card within console 226 splits the data being transmitted to a display 232 and/or the onboard touch screen of console 226 (FIG. 2).

In another embodiment, the media files are uploaded to the media servers 154a-r and then downloaded with the “run scheduler” file to instruction stations 102a-l, via one or more connections through network 106 (e.g., via the Internet).

Each one of instruction stations 102a-l may update its play list based on the schedules and media files downloaded. Instruction stations 102a-l play scheduled media on appropriate monitors, such as displays 808a-t. Instruction stations 102a-l may send confirmation notices when play of a play list and/or media file begins and ends.

There may be a number of advertising venues available to vendors. There may be multiple monitors and/or banners within each instruction station. At each of the franchisee portal, instructor portal, and student portal there may also be multiple places where advertisements may be placed. As a result of instruction stations 102a-l being communicatively connected via network 106, the advertisements may be displayed anywhere where there is an instruction station, student, and/or instructor, which could be anywhere in the world.

In addition, the vendors may include retail stores in which instruction stations 102a-i may be located. There may be separate portals provided for the local vendors, such as a store where the instruction stations are located. The portals for the local vendors may be used for the local vendor to run their own ads with media that the local vendors may provide to media servers 154a-r. The portals for the local vendors may run scheduler for scheduling advertisements.

There may be a utility located on media servers 806a-q that searches for or detects scheduling conflicts and/or overlapping content (two vendors requesting the display of ads for the same product). Media servers 806a-q may be accessed by an ad scheduler located on server system 104, available through an ad/media portal accessible through vendor portal 508 and/or franchisee portion 506 (FIG. 5). The ad scheduler may contains specific business rules, processes and automatic alerts that are executed when an advertising partner tries to schedule ad content that conflicts with a time-slot and/or issues specific to a particular one of or group of instruction stations 102a-l. For instance, in an embodiment, an advertiser cannot schedule a video ad to run during the same time another has been scheduled to run on the same instruction station. The scheduler will search and report back the closest instruction station by zip and city that has availability closest to the time slot requested. Communication path 812 may be used by franchisee network appliances 1114a-p (FIG. 1) to logon to vendor portal 508 (FIG. 5) approve and/or modify the advertisement schedules. In the case of a scheduling conflict, ad partner may be notified (e.g., by e-mail) and prompted to reschedule the ad.

Depending on the embodiment, the above system may be used for any physically oriented instructional venue that requires experts in a particular area to interact with people in the need of instruction. For example, engine and aircraft maintenance may be taught via the internet using an embodiment of the above system, and instructors may create tutorial training instructions that are distributed via the Internet using an embodiment of the above system.

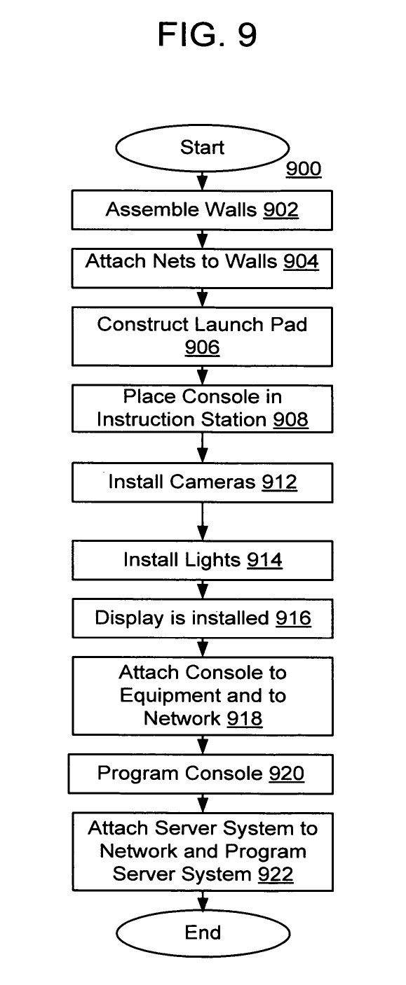

FIG. 9 is a method of setting up instruction system 100. In step 902, the walls of the instruction stations are assembled. In step 904, nets are attached to the walls to catch the balls. In step 906, launch pad 208 is constructed, which may include marking on launch pad 208 left pad 210, left foot position 212, right foot position 214, right pad, 216, right foot position 218, and left foot position 220 (FIG. 2). Assembling launch pad 208 may also include assembling and installing microphone 224 (FIG. 2). In step 908, console 226 is assembled and placed in instruction station 200 (FIG. 2). In step 912, left camera 228, back camera 230, and right cameral 232 are assembled and installed (FIG. 2). In step 914, lights are assembled and installed. In step 916, display 234 is assembled and installed (FIG. 2). In step 918, console 226 is attached to network 106 (FIG. 1A) and to various pieces of equipment associated with instruction station 200, such as microphone 224, left camera 228, back camera 230, right cameral 232, display 234, and lights 236. In step 920, console 226 is programmed. For example, console 226 may be configured to accept input from and/or control the pieces of equipment to which console 226 is attached, which may involve installing processing instructions 408, control instructions 410, and communications instructions onto console 226 (FIG. 4). Similarly, console 226 may be configured to communicate with server system 104 (e.g., web servers 152a-q, media servers 154a-r, and/or administrative server system 156, see FIG. 1B).

In step 922, server system 104 is assembled, attached to network 106, and programmed (FIG. 1A). Step 922 may involve assembling web servers 152a-q, media servers 154a-r, administrative server system 156 (FIG. 1B). Step 922 may also involve installing student portal 502, instructor portion 504, franchisee portal 506, and vendor portal 508 (FIG. 5) onto web servers 152a-q. Step 922 may also involve installing management portion 510 onto administrative server system 156.

In an embodiment, each of the steps of method 900 is a distinct step. In another embodiment, although depicted as distinct steps in FIG. 9, steps 902-922 may not be distinct from one another. In other embodiments, method 900 may not have all of the above steps and/or may have other steps in addition to or instead of those listed above. The steps of method 900 may be performed in another order. Although in one embodiment the steps of method 900 are preformed in the order listed above, in other embodiments the steps of method 900 may be performed in another order, and only some of, or possibly none of, the steps of method 900 are preformed in the order listed above. Subsets of the steps listed above as part of method 900 may be used to form their own method.

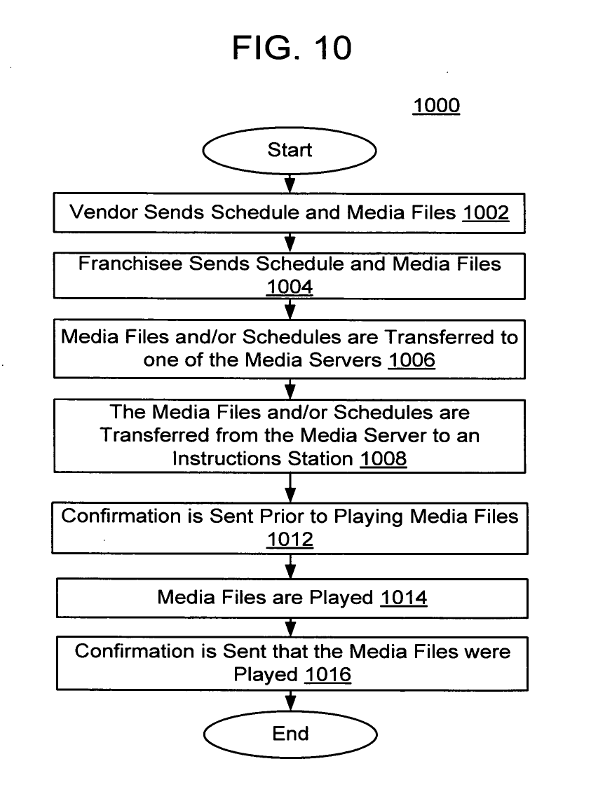

FIG. 10 shows a flowchart of an example of a method of updating advertisements on instruction system 100. In step 1002, a vendor, using vendor portal 508 (FIG. 5), enters advertisement schedules and media files for display in one or more of instruction stations 102a-l (FIG. 1A). For example, the vendor enters the vendor portal at one or more of web servers 152a-q (FIG. 1B), and inputs information and/or instructions. In an embodiment, in response to receiving the information and/or instructions the one or more web servers forward the information and/or instructions to one or more of media servers 154a-r (FIG. 1B). In another embodiment, in response to receiving the information and/or instructions the one or more web servers forward the information and/or instructions to administrative server system 104.

In step 1004, franchisees, via franchisee portal 506 (FIG. 5), enter media files, advertisements schedules, and/or approve or reject the schedules and media files entered by the vendors. For example, the franchisee enters the franchisee portal at one or more of web servers 152a-q (FIG. 1B), and inputs information and/or instructions. In an embodiment, in response to receiving the information and/or instructions the one or more web server forward the information and/or instructions directly to one or more of media servers 154a-r (FIG. 1B). In another embodiment, in response to receiving the information and/or instructions the one or more web servers forward the information and/or instructions to administrative server system 104.

In step 1006, the media files and/or schedules are transferred to media servers 154a-r. For example, the information and/or instructions received from one or more of web servers 152a-q (in steps 1002 and 1004) cause one or more of media servers 154a-r to download media files and/or schedules (e.g., from vendor network appliances 110a-m) (FIG. 1B). In the embodiment in which the information and/or instructions were forwarded directly to one or more of media servers 154a-r, the one or more media servers that received the instructions and/or information cause the media files to be transferred from vendor network appliances 110a-m to themselves. In the embodiment in which the information and/or instructions from one or more web servers 152a-q were forwarded to administrative server system 156 (FIG. 1B), administrative server system 156 causes the files to be transferred to one or more media servers 154a-r.

In step 1008, one or more of media servers 154a-r (FIG. 1B) transfer the files and/or schedules to instruction stations 102a-l (FIG. 1A) at a time when instruction stations 102a-l are not expected to be in use. In step 1010, a confirmation is sent to administrative server system 156 that the media file is about to be played. In step 1012, the media files are played (e.g., displayed). In step 1014, a confirmation is sent to administrative server system 156 that the media file was played.

In an embodiment, each of the steps of method 1000 is a distinct step. In another embodiment, although depicted as distinct steps in FIG. 10, steps 1002-1014 may not be distinct from one another. In other embodiments, method 1000 may not have all of the above steps and/or may have other steps in addition to or instead of those listed above. Although in one embodiment the steps of method 1000 are preformed in the order listed above, in other embodiments the steps of method 1000 may be performed in another order, and only some of, or possibly none of, the steps of method 1000 are preformed in the order listed above. Subsets of the steps listed above as part of method 1000 may be used to form their own method.

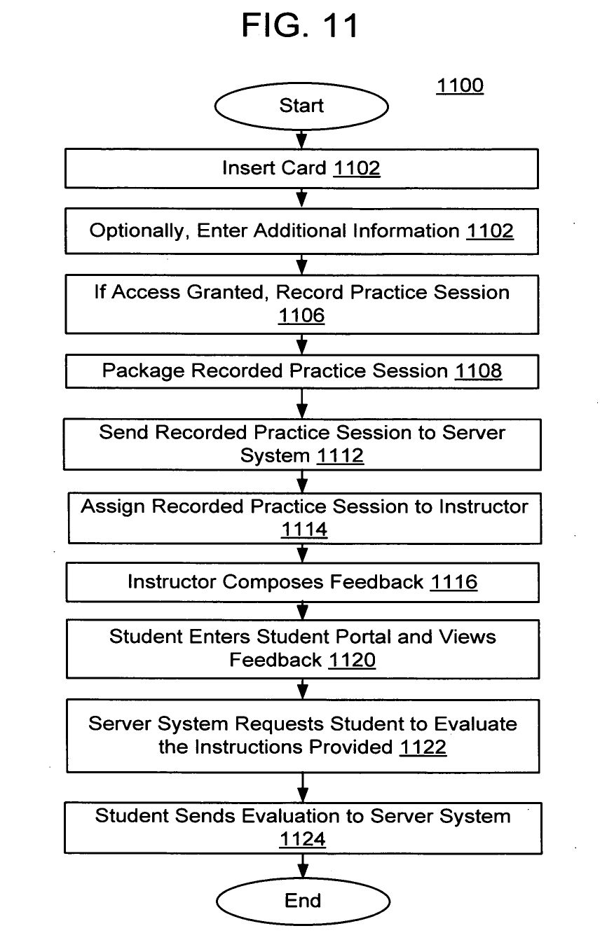

FIG. 11 shows a flowchart of an example of a method of using instruction system 100 (FIG. 1A). In step 1102 a student approaches one of instruction stations. 102a-l (FIG. 1A), and inserts a card into a card reader. Access to the instruction station is granted or denied based on the information on the student's card. For example, after reading the card access may first be denied based on lack of a sufficient payment from the student, and later, after the student pays more money, access may be granted. In step 1104, the student may enter various pieces of information, such as information further identifying the student, information related to the instructor being used, information related to the lessons being viewed, and/or information related to the practice sessions.

In step 1106, after access has been granted, the student fills out an automated survey of personal data and preference data. Then the student records a practice session. Step 1106 may involve the student entering various settings into console 226 and then taking several swings while left camera 228, back camera 230, and/or right camera 232 may record one or more aspects of the swings, trajectory of the ball, and/or the student's position while swinging (FIG. 2). During step 1106, microphone 224 may record sounds, such as the sound of the golf club hitting the ball and/or screen 204 (FIG. 2).

In step 1108, the recordings of the practice session are packaged into one file. Additionally, the survey of personal data and preference data may be packaged with the video into the file so that the coach that views the student data has information about the student, which may identify the student and/or provide context for the recorded practice sessions. In step 1110, the recorded practice session is sent to server system 104. At server system 104, the recorded practice session may be placed in one or more instructor queues to wait for an instructor to select the recorded practice session for viewing. The student may receive a notification that the recorded practice session will be reviewed. For example, the student may get and e-mail stating, “thanks, we will notify you when your recorded practice session has been reviewed,” or “thanks, we will notify you when your recorded practice session is being reviewed.”

In step 1112, the file is assigned to an instructor. Step 1112 may involve receiving communications from an instructor requesting a recorded practice session to view, and selecting the recorded practice session for the instructor to view. The selection may be based on which recorded practice session is next in the queue, preferences requested by the student relating to the type of instructor, the level of the student, and/or a request for a specific instructor. In step 1112, after a file is selected to be assigned to an instructor, the instructor may receive a notification that the file was assigned to the instructor. Also, the student may receive a copy, or a link to a copy, of the resume of the instructor. In step 1112, the student may be notified that the instructor is reviewing the recorded practice session. For example, the student may get and e-mail stating, “thanks, we will notify you when your recorded practice session has been reviewed” and then “your instructor is working on reviewing your recorded practice session and here is a link to his/her resume, photo.”

In step 1114, the instructor views the recorded practice session, and analyzes the recorded practice session and optionally other data that may have been provided by the student. In step 1116, the instructor composes comments for the student related to the recorded practice session. Composing the comments may involve manipulating graphics and audio messages to form images related to proper positioning of the student's body while swinging the a golf club. Composing the comments may also include annotating one or more frames of the recorded practice session with sound, text, and/or graphics. The graphics may include arrows pointing to certain parts of the body of the student whose positioning the instructor is commenting on. In step 1116, server system 104 (FIG. 1B) may send a notification to the student that the comments and/or lesson are ready for the student to view.

In step 1120, the student logs into a student web portal (by entering a password and/or student identification into one or more fields of a webpage) to review (e.g., to listen, view, and/or read) the comments. The comments may be reviewed online and/or downloaded to the student network appliance. In step 1122, server system 104 may send one or more feedback forms for the student to complete regarding the student's satisfaction using system 100 and/or the student's satisfaction with the instructor. If the student is not already a member, server system 104 may send a membership application. In step 1124, the student fills out and returns the one or more feedback form and/or the membership application.

In an embodiment, each of the steps of method 1100 is a distinct step. In another embodiment, although depicted as distinct steps in FIG. 11, steps 1102-1124 may not be distinct from one another. In other embodiments, method 1100 may not have all of the above steps and/or may have other steps in addition to or instead of those listed above. Although in one embodiment the steps of method 1100 are preformed in the order listed above, in other embodiments the steps of method 1100 may be performed in another order, and only some of, or possibly none of, the steps of method 1100 are preformed in the order listed above. Subsets of the steps listed above as part of method 1100 may be used to form their own method.

Each embodiment disclosed herein may be used or otherwise combined with any of the other embodiments disclosed. Any element of any embodiment may be used in any embodiment.

Although the invention has been described with reference to specific embodiments, it will be understood by those skilled in the art that various changes may be made and equivalents may be substituted for elements thereof without departing from the true spirit and scope of the invention. In addition, modifications may be made without departing from the essential teachings of the invention.

1. A system comprising
at least one site having at least recording equipment that is capable of at least capturing a video of an action, wherein the recording equipment is configured for capturing a particular type of action; and
a machine-readable medium storing one or more instructions for automatically configuring the system to at least capture the video of the action based on user input.

2. The system of claim 1, wherein the at least one site further comprises at least one console for at least running the one or more instructions for automatically configuring the system.

3. The system of claim 1, wherein the machine readable medium also stores one or more instructions for editing the video.

4. The system of claim 1, wherein the machine readable medium also stores one or more instructions for at least removing segments of the video that are outside of one or more specified time periods within which one or more occurrences of the action occurred.

5. The system of claim 4, wherein the action is hitting a ball.

6. The system of claim 1, wherein the at least one site includes at least an indication of a position for a user to stand while performing the action.

7. The system of claim 1, further comprising at least a second site for at least facilitating the reviewing of the video by an instructor.

8. The system of claim 7, wherein
the second site is configured for at least
storing a queue of video files, and
selecting one or more of the video files from the queue.

9. The system of claim 8, wherein the system is configured for at least receiving a request for a video file to review, and the selecting is in response to the receiving.

10. The system of claim 1, further comprising a second site being configured for at least receiving media files and scheduling information for displaying the media files.

11. The system of claim 1, wherein the at least one site is a plurality of instruction stations, wherein each instruction station includes at least
a display,
a plurality of cameras,
a plurality of lights, and
a console that runs the one or more instructions, wherein the one or more instructions include at least one or more instructions for controlling the plurality of cameras and lights for creating the video of the action, and
editing the video to remove portions that are not within one or more time periods during which one or more occurrences of the actions are expected to have occurred,
the console being configured for at least
displaying media files on the display,
receiving scheduling information for displaying the media files, and
receiving the media files to display;
the system further comprising
one or more web servers having at least
a portal for students to at least receive communications from instructors
a portal for instructors to at least
receive recorded practice sessions to review,
convey messages related to the recorded practice sessions, and
post information related to the instructors,
a portal for franchisees to at least
monitor financial activities and
manage marketing, and
a portal for vendors to at least
transfer the media files to the instruction stations, and
transfer scheduling information for displaying the media files; and
a server for monitoring activities associated with the instruction stations.

12. A system comprising
at least one site that is capable of at least, automatically capturing a video of at least an action of a user;
at least one site that is capable of at least queuing, delivering and reviewing the action captured on video;
at least one site that is capable of at least scheduling, prioritizing and presenting any number of multimedia file formats through at least one additional peripheral monitor; and
a machine-readable medium storing instructions for automatically causing the system to forward the video of the user to an instructor.

13. A method comprising:
receiving information about a user; and
automatically configuring a system for capturing images of an action of the user based on the information.

14. The method of claim 13, further comprising:
capturing the images of the user
automatically editing the images of the user, and
storing the images edited.

15. The method of claim 14, wherein the action is a set of one or more actions, and the automatically editing of the images includes at least
removing segments of the video that are outside of one or more specified time periods within which the one or more actions are expected to have occurred.

16. The method of claim 13, further comprising:
transferring the images to a site where the images are available for review.

17. The method of claim 13, further comprising, at another site receiving comments related to the images.

18. The method of claim 13, further comprising receiving scheduling information for displaying media files, and
displaying the media files based on the scheduling information.

19. The method of claim 13, wherein the action is hitting a ball.

20. A system comprising a machine readable medium storing thereon instructions for
assigning recorded practice session to an instructor for review;
receiving comments about the recorded practice session from the instructor; and
providing to a student access to the comments.
